(19) United States
(12) Patent Application Publication
(10) Pub. No.: US 2011/0117960 A1
(43) Pub. Date: May 19, 2011

(54) ELECTRONIC DEVICE AND IMAGING METHOD

(75) Inventor: Takashi Miura, Kanagawa (JP)

(73) Assignee: KYOCERA CORPORATION, Kyoto (JP)

(21) Appl. No.: 13/000,672

(22) PCT Filed: Jun. 26, 2009
(86) PCT No.: PCT/JP2009/061787

§ 371 Date: Dec. 22, 2010

(30) Foreign Application Priority Data
Jun. 27, 2008 (JP) 2008-169677

(51) Int. Cl. H04M 1/00

(52) U.S. Cl. 455/556.1

(57) ABSTRACT

Provided are an electronic device and an imaging method which improve the zoom operability. A mobile telephone (1) includes: a case; a camera unit (23) arranged in the case; a display unit (21) which displays an image captured by the camera unit (23); and a control unit (30) which controls zoom of the image captured by the camera unit (23). The control unit (30) detects displacement of the case according to a detection value of an acceleration sensor (31) and controls the captured image zoom according to the detected case displacement.

### TECHNICAL FIELD

The present invention relates to an electronic device with an image capturing unit and an image capturing method.

### BACKGROUND ART

Electronic devices such as cellular telephones that are conventionally distributed in a market have an image capturing unit with a zoom feature (see, for example, Patent Document 1). Further, the image capturing unit has the zoom feature, so that users can adjust the size of an image and photograph an object.

[Patent Publication 1] Japanese Unexamined Patent Application, Publication No. 2002-374450

### DISCLOSURE OF THE INVENTION

### Problems to be Solved by the Invention

By the way, for example, an input to enlarge and reduce a captured image by the above zoom feature is performed according to a command by operation keys provided in an electronic device. Therefore, there is a problem that the operation of the zoom feature is difficult for users.

It is an objective of the present invention to provide an electronic device with a zoom feature for a captured image and an image capturing method.

### Means for Solving the Problems

The electronic device according to the present invention has: a body; an image capturing unit disposed in the body; a display unit that displays a captured image by the image capturing unit; a zoom control unit that controls zoom of the captured image by the image capturing unit; and a displacement detection unit that detects displacement of the body, and the zoom control unit controls zoom of the captured image based on the displacement of the body detected by the displacement detection unit.

In addition, it is preferable that the electronic device according to the present invention further has an acceleration sensor that detects acceleration, and is provided in the body, and the displacement detection unit detects the displacement of the body based on the acceleration detected by the acceleration sensor.

In addition, it is preferable that the electronic device according to the present invention further has a focus determination unit that determines a degree of focus of the captured image by the image capturing unit, and the displacement detection unit detects the displacement of the body based on a change of the degree of focus of the captured image determined by the focus determination unit.

In addition, it is preferable that the displacement detection unit detects the displacement of the body in an image capturing direction of the image capturing unit.

In addition, it is preferable that the zoom control unit controls zoom of the captured image when the degree of focus determined by the focus determination unit changes to be over a predetermined value.

In addition, it is preferable that the zoom control unit enlarges the captured image when the displacement detection unit detects the displacement of the body in a direction towards an object.

In addition, it is preferable that the zoom control unit reduces the captured image when the displacement detection unit detects the displacement of the body in a direction away from an object.

In addition, it is preferable that the zoom control unit controls the zoom of the image based on a degree of the displacement of the body detected by the displacement detection unit.

In addition, it is preferable that the electronic device according to the present invention further has a storage unit that stores data indicating a relationship between the degree of the displacement of the body and a degree of zoom, and the zoom control unit extracts the degree of zoom associated with the degree of the displacement of the body detected by the displacement detection unit, from the data stored in the storage unit, and controls the zoom of the captured image according to the extracted degree of zoom.

In addition, it is preferable that the electronic device according to the present invention further has a zoom change command unit that commands a change of a degree of the zoom of the image, and the zoom control unit controls the zoom of the image according to the detected displacement of the body and a zoom change command by the zoom change command unit.

In addition, it is preferable that, when a zoom change is commanded by the zoom change command unit within a predetermined time after the displacement of the body is detected, the zoom control unit changes the zoom of the image according to the command.

In addition, it is preferable that the displacement detection unit measures a continuation time of the displacement of the body; and when the continuation time measured by the displacement detection unit is longer than a predetermined time, the zoom control unit controls the zoom of the captured image.

In addition, it is preferable that the displacement detection unit detects the displacement of the body according to a maximum value of the acceleration detected by the acceleration sensor.

In addition, it is preferable that the zoom control unit controls the zoom of the image based on the displacement of the body when a close-up mode is set.

The image capturing method according to the present invention is an image capturing method in an electronic device having a display unit that displays a captured image by an image capturing unit provided in a body, and includes detecting displacement of the body and controlling zoom of the captured image based on the detected displacement of the body.

### EFFECTS OF THE INVENTION

According to the present invention, zoom control for an captured image becomes easy in an electronic device.

### BRIEF DESCRIPTION OF THE DRAWINGS

FIG. 1 is a front perspective view in a state in which a cellular telephone 1 according to Embodiment 1 is opened;

FIG. 2 is a back surface view in a state in which the cellular telephone 1 according to Embodiment 1 is opened;

FIG. 3 is a block diagram showing features of the cellular telephone 1 according to Embodiment 1;

FIG. 4 is a diagram showing an acceleration table according to Embodiment 1;

FIG. 5 is a diagram showing a change of an angle of view of a camera unit 23 in the case that the cellular telephone 1 according to Embodiment 1 is moved away from an object;

FIG. 6 is a diagram showing a change of an angle of view of the camera unit 23 in the case that the cellular telephone 1 according to Embodiment 1 is moved towards an object;

FIG. 7 is a flowchart showing processing of a control unit 30 according to Embodiment 1;

FIG. 8 is a block diagram showing features of the cellular telephone 1 according to Embodiment 2;

FIG. 9 is a flowchart showing processing of the control unit 30 according to Embodiment 2:

FIG. 10 is a diagram showing how an acceleration table according to Embodiment 3 is corrected; and

FIG. 11 is a flowchart showing processing of the control unit 30 according to Embodiment 3.

### EXPLANATION OF REFERENCE NUMERALS

1 CELLULAR TELEPHONE (ELECTRONIC DEVICE)
2 OPERATION UNIT SIDE BODY (BODY)
3 DISPLAY UNIT SIDE BODY (BODY)
11 OPERATION UNIT (ZOOM CHANGE COMMAND UNIT)
21 DISPLAY UNIT
23 CAMERA UNIT (IMAGE CAPTURING UNIT)
23a LENS UNIT
30 CONTROL UNIT (ZOOM CONTROL UNIT, DISPLACEMENT DETECTION UNIT, ZOOM CHANGE COMMAND UNIT)
31 ACCELERATION SENSOR
32 MEMORY (STORAGE UNIT)
33 TIMER (DISPLACEMENT DETECTION UNIT)
201 IMAGE CAPTURING ELEMENT
202 IMAGE PROCESSING UNIT
203 FOCUS PROCESSING UNIT (FOCUS DETERMINATION UNIT)

### PREFERRED MODE FOR CARRYING OUT THE INVENTION

### Embodiment 1

A description is provided hereinafter regarding Embodiment 1 of the present invention. In addition, a description is provided regarding the cellular telephone 1 as an example of an electronic device. However, embodiments of the present invention are not limited to this Embodiment 1. For example, the present invention is also applicable to various electronic devices with an image capturing device such as PHS (Personal Handy Phone System), PDA (Personal Digital Assistant) and so on.

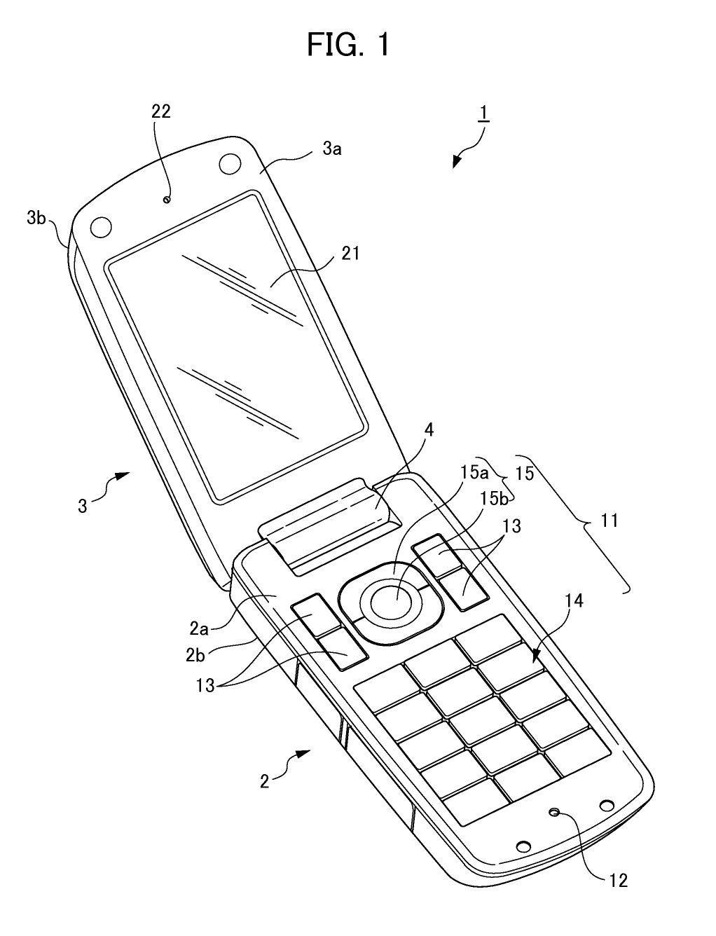

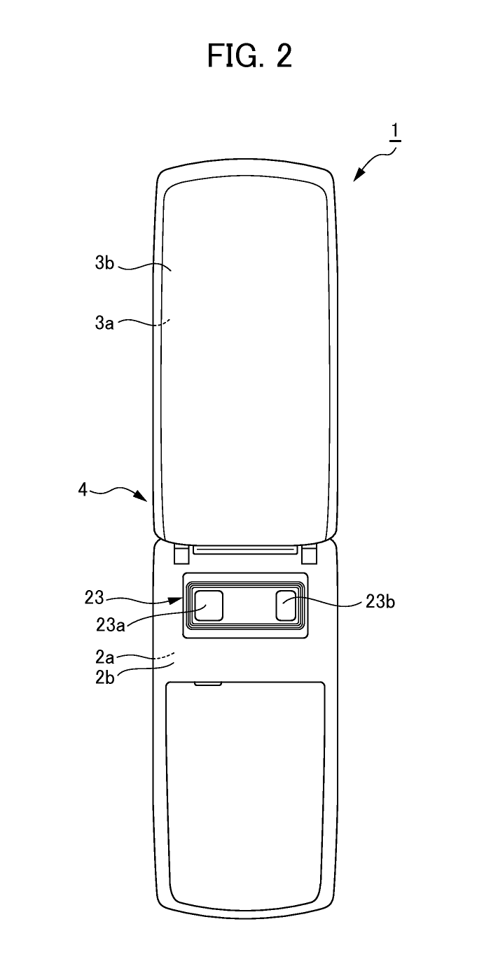

FIG. 1 is a front perspective view in a state in which the cellular telephone 1 according to the present embodiment is opened. FIG. 2 is a back surface view in a state in which the cellular telephone 1 is opened.

As shown in FIG. 1 and FIG. 2, the cellular telephone 1 has an operation unit side body 2 and a display unit side body 3 as bodies. The operation unit side body 2 and display unit side body 3 are openably and closably connected via a connection unit 4 having a hinge mechanism. More specifically, an upper end portion of the operation unit side body 2 and a lower end portion of the display unit side body 3 are connected via the connection unit 4. This allows the cellular telephone 1 to relatively move the operation unit side body 2 and display unit side body 3 connected via the hinge mechanism. That is, the cellular telephone 1 can change into a state in which the operation unit side body 2 and display unit side body 3 are opened (opened state) and a state in which the operation unit side body 2 and display unit side body 3 are folded (closed state). Here, the closed state is a state in which both bodies are disposed to overlap each other, and the opened state is a state in which both bodies are disposed not to overlap each other.

The outer surface of the operation unit side body 2 is composed of a front case 2a and a rear case 2b. The operation unit side body 2 is configured such that an operation unit 11 and a microphone 12 that takes in voice that the user of the cellular phone 1 utters in communication are each exposed on the front case 2a side. In addition, as shown in FIG. 2, the operation unit side body 2 disposes a lens unit 23a and a flash unit 23b composing the camera unit 23 to be exposed on the rear case 2b side.

The operation unit 11 includes: feature setting operation keys 13 for operating various settings and various features such as a telephone number directory feature and a mail feature, input operation keys 14 for inputting digits and so on of a telephone number and characters for mail, and a selection operation key 15 that performs, for example, selection of the various operations and scrolling in up, down, left and right directions and so on. The selection key 15 is composed of an annular key 15a and a circular key 15b. Each key composing the operation unit 11 is assigned a predetermined feature (key assign) according to, for example, the opened/closed state of the operation unit side body 2 and display unit side body 3, various modes or the type of an activated application. Then, when the user presses each key, the event matching the feature assigned to each key is executed. More specifically, when, for example, the cellular telephone 1 is in a camera mode and the selection operation key 15 is pressed, a feature of adjusting of an image capturing magnification or commanding capturing of an image are executed. That is, each key is assigned a feature such that the image capturing magnification is adjusted when the annular key 15a is pressed and capturing of an image is commanded at a predetermined magnification when the circular key 15b is pressed.

The microphone 12 is disposed on the outer end portion side opposite to the connection unit 4 side in a longitudinal direction of the operation unit side body 2. That is, the microphone 12 is disposed on the one outer end portion side in the opened state of the cellular telephone 1.

The outer surface of the display unit side body 3 is composed of a front case 3a and a rear case 3b. In the front case 3a of the display unit side body 3, a display unit 21 for displaying various pieces of information including, for example, a captured image and a speaker 22 functioning as a receiver for outputting a communicating party's voice are disposed to be exposed.

The display unit 21 is composed of a liquid crystal panel, a drive circuit for driving this liquid crystal panel and a light source unit such as a backlight for radiating light on the back surface of this liquid crystal panel.

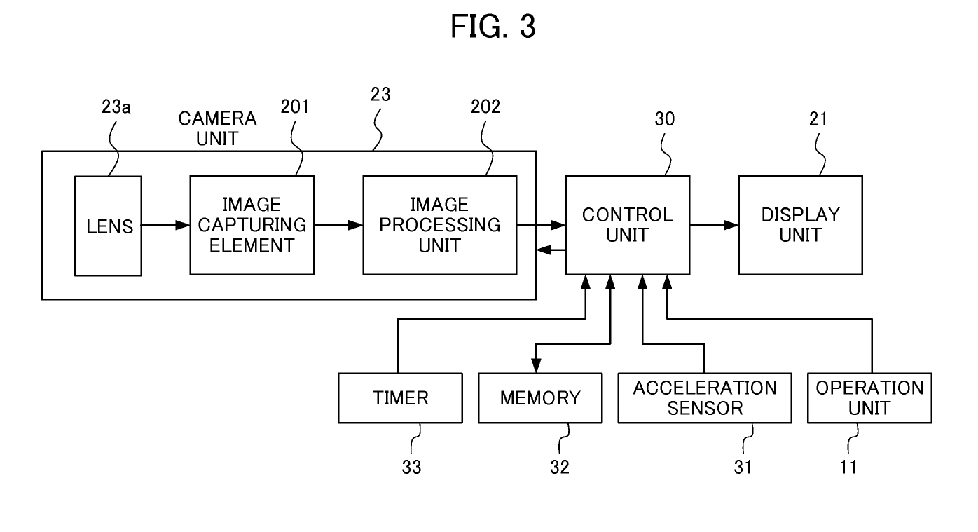

The display unit 21 is configured to continuously display images of an object that are captured. The display unit 21 is an LCD (Liquid Crystal Display) for sequentially performing drawing processing based on charge signals sequentially read from an image capturing element 201 (see FIG. 3). The photographer can adjust, for example, an image magnification by the annular key 15a of the selection operation key 15 looking at an image of the object to be displayed on the display unit 21, and can capture an image of the object such as a person by pressing the circular key 15b with the image capturing condition such as a desired image magnification. Here, with the present embodiment, in addition to adjustment of the magnification by this annular key 15a, the cellular telephone 1 adjusts the magnification (zoom control) based on a detected value of an acceleration sensor 31 described later (in FIG. 3)

With the present embodiment, a description is provided regarding a folder-type cellular telephone 1 that can be folded via the connection unit 4. However, the cellular telephone may not be a folder-type, and may be a slider-type for sliding one body in one direction in a state in which the operation unit side body 2 and display unit side body 3 are overlapped; a rotation (horizontal rotation) type for rotating one body about the axis along the direction in which the operation unit side body 2 and display unit side body 3 are overlapped; or a type (straight type) for disposing the operation unit side body 2 and display unit side body 3 in one body without a connection unit.

FIG. 3 is a block diagram showing features of the cellular telephone 1 according to the present embodiment. The cellular telephone 1 has the operation unit 11, display unit 21, camera unit 23, control unit 30, acceleration sensor 31, memory 32 and timer 33.

The display unit 21 performs predetermined image processing according to control by the control unit 30. Further, the display unit 21 accumulates processed image data in a frame memory, and outputs images at predetermined timings.

The camera unit 23 has the lens unit 23a, image capturing element 201 and image processing unit 202. The image capturing element 201 converts the light inputted via the lens unit 23a, into a charge signal. The image processing unit 202 generates image data based on this charge signal, and delivers image data to the control unit 30.

The control unit 30 (zoom control unit) controls the cellular telephone 1 entirely, and, for example, performs predetermined control for the display unit 21, camera unit 23 and so on. In addition, upon receiving inputs from, for example, the operation unit 11, acceleration sensor 31 and timer 33, the control unit 30 executes various processings. Furthermore, when executing processings, the control unit 30 controls the memory 32 to read various programs and data, and write data.

The acceleration sensor 31 detects the acceleration in the direction from the front case 2a to the rear case 2b. The acceleration sensor 31 measures the acceleration (a) based on the force (F) applied from outside and mass (m) (acceleration (a)=force (F)/mass (m)). Note that, although the acceleration sensor 31 of the present embodiment is the single axis type, embodiments are not limited to the single axis type. A multi-axis sensor with two axes or more provided for games and other applications may be used.

In addition, a voice coil motor composing a part of the lens unit 23a causes electromagnetic induction when the camera unit 23 is shaken, and therefore the acceleration sensor 31 may be configured to detect the acceleration based on the current which is generated at this time.

Furthermore, the acceleration sensor 31, for example, measures the force applied to predetermined mass by a piezoelectric element and finds the acceleration per axis, and converts the acceleration into numerical data and buffers it. Moreover, the control unit 30 reads periodically buffered acceleration data. Note that the acceleration sensor 31 is not limited to a piezoelectric element (piezoelectric type), and may be configured by, for example, an MEMS (Micro Electro Mechanical Systems) type such as a piezoresistance type, a capacitance type or thermal detection type, a servo type for operating a moving coil and reversing the moving coil with a feedback current or a distortion gauge type for measuring distortion generated by the acceleration using a distortion gauge.

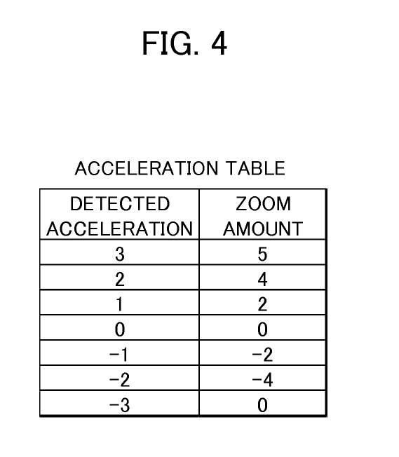

The memory 32 includes, for example, a working memory, and is utilized for arithmetic processing by the control unit 30. More specifically, the memory 32 stores, for example, an acceleration table (FIG. 4) described later. Note that the memory 32 may function as a detachable external memory as well.

The timer 33 measures a predetermined time based on the command from the control unit 30, and notifies the time to the control unit 30. By this means, the control unit 30 can branch the content of processing depending on whether or not a predetermined time passed.

A description is provided hereinafter regarding the operations of the acceleration sensor 31 and control unit 30. The acceleration sensor 31 detects the value of the acceleration applied to the cellular telephone 1 as acceleration data on a regular basis. In addition, the control unit 30 reads the acceleration data detected by this acceleration sensor 31.

Based on the detected acceleration data, the control unit 30 detects the position change (body displacement) in an image capturing direction by the cellular telephone 1 (body). More specifically, the “position change” refers to the distinction between movement in the forward direction and movement in the reverse direction with respect to the image capturing direction, and the degree of the acceleration. Note that the control unit 30 may detect the position change using not only the degree of the acceleration, but also, for example, a displacement speed, displacement time and displacement distance detected based on the detected acceleration.

By the way, a human action always causes jiggling, and therefore the acceleration accompanying movement of user's cellular telephone 1 never takes a constant value. That is, the acceleration changes from the start to the end of movement, and the plus/minus of the value reverses. In view of above, with the present embodiment, the acceleration at an early stage of movement is adopted, and the acceleration that maximizes during this movement is the degree of the acceleration.

Note that the method of detecting the position change is not limited to this, and a predetermined detection rule may be set. For example, regarding the plus/minus of the acceleration, the direction of a longer connection time may be judged as the direction of movement. The degree of the acceleration is not limited to the maximum value, and may be, for example, an average value or integrated value.

Next, the control unit 30 reads from the memory 32 the table indicating the relationship between the position change and the zoom amount. Then, the control unit 30 controls the camera unit 23 based on data of the read table, and adjusts the degree of zoom of the captured image by the camera unit 23.

FIG. 4 is a diagram showing an acceleration table defining the relationship between the position change (body displacement) and the zoom amount according to the present embodiment. Here, a value indicating the orientation and the degree of the acceleration detected as the position change (acceleration level) is associated with the amount of change of the degree of zoom.

The control unit 30 refers to the acceleration table of FIG. 4, and, for example, adjusts zoom to “+5” when the acceleration level “3” is detected. By this means, by moving the cellular telephone 1 back and forth, the user can execute zoom according to the direction and strength of the movement of the cellular telephone 1.

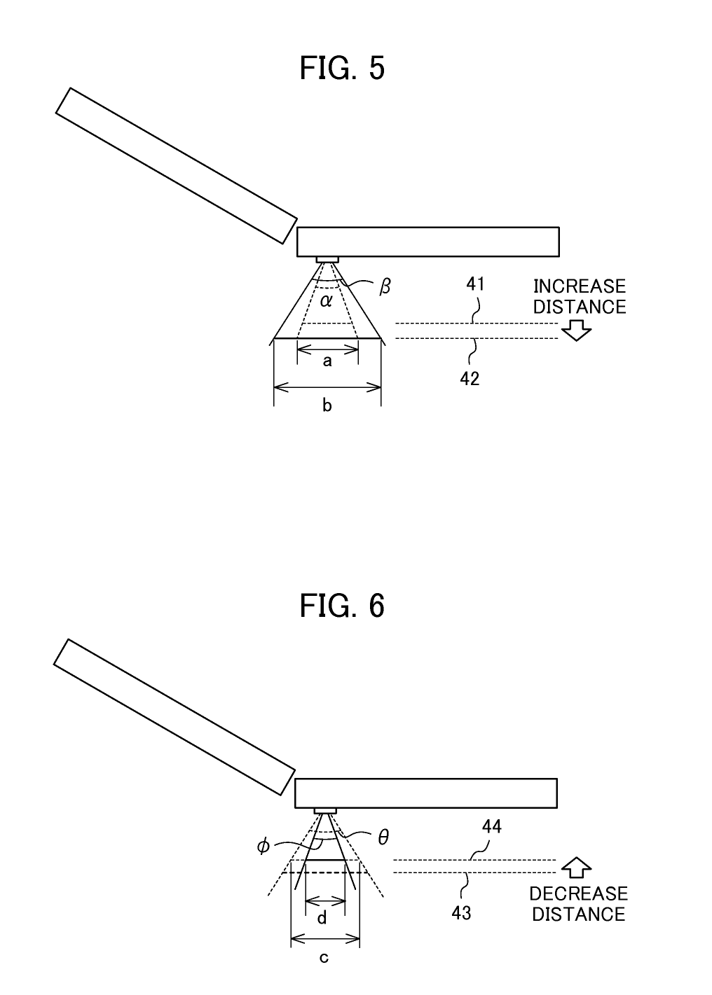

FIG. 5 is a diagram showing a change of an angle of view of the camera unit 23 in the case that the cellular telephone 1 according to the present embodiment is moved away from an object.

When the position of the object changes from an object plane 41 to an object plane 42 and the distance between the object and the camera unit 23 becomes longer, if the angle of view of the camera unit 23 is an angle of view α, the image capturing range is the distance a on the object plane 42. Then, when the control unit 30 executes zoom down and widen the angle of view to β with the present embodiment, the image capturing range is the distance b on the object plane 42.

FIG. 6 is a diagram showing a change of an angle of view of the camera unit 23 in the case that the cellular telephone 1 according to the present embodiment is moved towards an object.

By contrast with FIG. 5, when the position of the object changes from the object plane 43 to the object plane 44 and the distance between the object and the camera unit 23 becomes short, if the angle of view of the camera unit 23 is an angle of view θ, the image capturing range is the distance c on the object plane 44. Then, when the control unit 30 executes zoom up to narrow the angle of view to φ with the present embodiment, the image capturing range is the distance d on the object plane 44.

In this way, zoom up and zoom down are executed when the cellular telephone 1 is moved towards or moved away from the object, so that the user can perform a zoom operation matching user's taste. In addition, a great zoom effect can be acquired with a little movement of the cellular telephone 1, so that the user can capture an image of a desired size without substantially losing the object from a focal length.

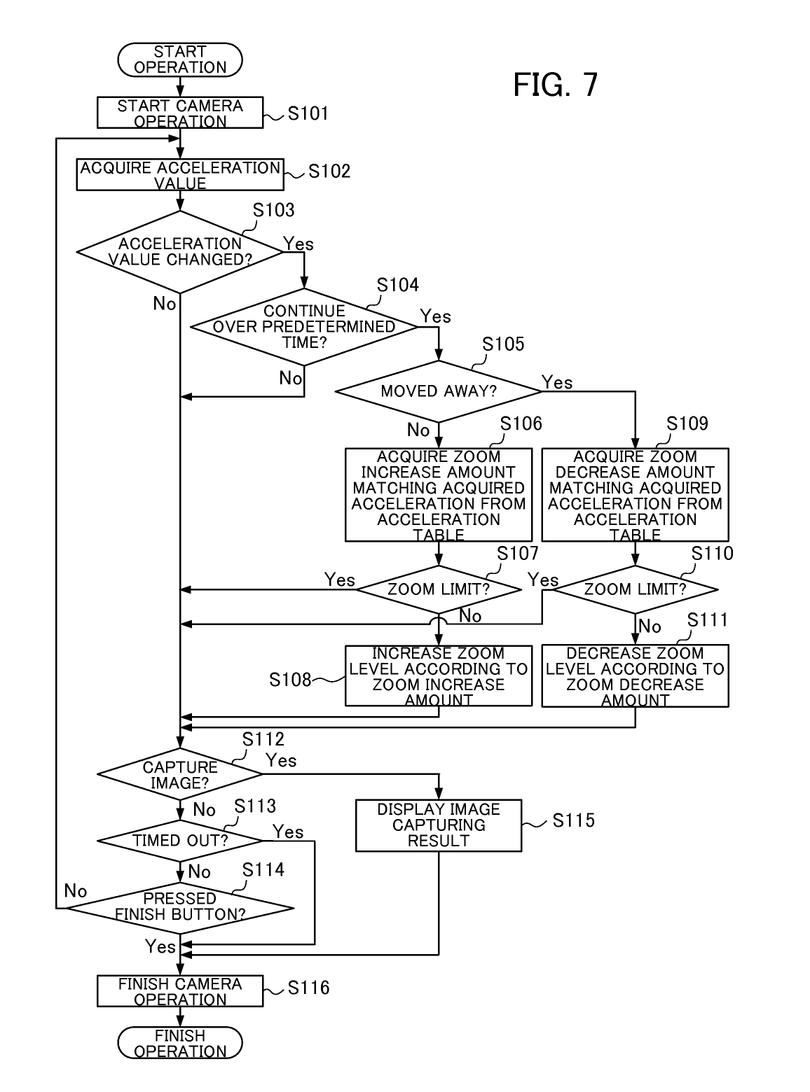

FIG. 7 is a flowchart showing processing of the control unit 30 according to the present embodiment.

In step S101, the control unit 30 starts the behavior of the camera unit 23 according to the operation inputted by the user.

In step S102, the control unit 30 acquires an acceleration value from the acceleration sensor 31. The control unit 30 periodically acquires acceleration values, thus can refer to the transition of the acceleration values in a predetermined period up to this point of time.

In step S103, the control unit 30 determines whether or not the acceleration value acquired in step S102 changed. The control unit 30 monitors the transition of the acceleration values from the past, and determines that the acceleration value changed when a change corresponding to a predetermined threshold or greater takes place. Instead, the acceleration value is in the vicinity of zero when the cellular telephone 1 stops, and therefore the control unit 30 may determine that the acceleration value changed when it becomes a predetermined value or more. The control unit 30 moves the processing to step S104 when this determination is YES, and moves the processing to step S112 when this determination is NO.

In step S104, the control unit 30 determines whether or not the change of the acceleration value (body displacement) determined in step S103 continues over a predetermined time. When this determination is YES, the control unit 30 judges that the user intentionally moved the cellular telephone 1 and moves the processing to step S105, and, when this determination is NO, the control unit 30 judges that the user made an unintentional movement such as a jiggling of a hand and moves the processing to step S112.

In step S105, the control unit 30 determines whether or not the cellular telephone 1 was moved away from the object. That is, the control unit 30 determines whether the orientation of the acceleration as body displacement is the direction opposite to the object and the cellular telephone 1 was moved away from the object or not. When this determination is YES, that is, when the determination is made that the cellular telephone 1 was moved away from the object, the control unit 30 moves the processing to step S109. In addition, when this determination is NO, that is, when the determination is made that the cellular telephone 1 was not moved away from the object, the control unit 30 moves the processing to step S106.

In step S106, the control unit 30 acquires the amount of increase of zoom from the acceleration table (FIG. 4) according to the acquired acceleration level.

In step S107, the control unit 30 determines whether or not the current degree of zoom is the limit of a zoom adjustable range. The control unit 30 moves the processing to step S112 when this determination is YES, and moves the processing to step S108 when this determination is NO.

In step S108, the control unit 30 controls the camera unit 23 according to the zoom increase amount acquired in step S106, and increases the zoom level of the camera unit 23.

In step S109, the control unit 30 acquires the amount of decrease of zoom from the acceleration table (FIG. 4) according to the acquired acceleration level.

In step S110, the control unit 30 determines whether or not the current degree of zoom is the limit of a zoom adjustable range. The control unit 30 moves the processing to step S112 when this determination is YES, and moves the processing to step S111 when this determination is NO.

In step S111, the control unit 30 controls the camera unit 23 according to the zoom decrease amount acquired in step S109, and decreases the zoom level of the camera unit 23.

In step S112, the control unit 30 determines whether or not the operation of capturing an image was performed. More specifically, when pressing of, for example, the circular key 15b (FIG. 1) is detected, the control unit 30 determines that the operation of capturing an image was performed. The control unit 30 moves the processing to step S115 when this determination is YES, and moves the processing to step S113 when this determination is NO.

In step S113, the control unit 30 determines whether or not a predetermined time passed (timed out) without execution of the operation of capturing an image being determined in step S112. The control unit 30 moves the processing to step S116 when this determination is YES, and moves the processing to step S114 when this determination is NO.

In step S114, the control unit 30 determines whether or not the operation of finishing the camera feature is performed. More specifically, when pressing of, for example, a finish button of the feature setting operation keys 13 (FIG. 1) is detected, the control unit 30 determines that the operation of finishing the camera feature was performed. The control unit 30 moves the processing to step S116 when this determination is YES, and returns processing to step S102 and repeats zoom processing when this determination is NO.

In step S116, the control unit 30 finishes the operation of the camera unit 23 and finishes processing.

With the present embodiment, the cellular telephone 1 performs zoom control by detecting whether or not the cellular telephone 1 was moved towards or moved away from the object without accepting a zoom setting from the operation unit 11. The operation of performing enlargement when the cellular telephone 1 is moved towards the object and performing reduction when the cellular telephone 1 is moved away from the object is intuitively easy for users to understand. Consequently, users can perform zoom up and zoom down easily by an intuitive operation.

In addition, with the present embodiment, the control unit 30 uses the detected value of the acceleration sensor 30 to detect the position change of the cellular telephone 1. There are many cases that acceleration sensors are already mounted even on conventional cellular telephones to use for games and other features, and therefore the cellular telephone 1 of the present embodiment are realized by utilizing this acceleration sensor without adding new parts.

In addition, with the present embodiment, the memory 32 that the cellular telephone 1 has stores the relationship between the acceleration and the zoom amount in advance. By this means, the control unit 30 can immediately determine the zoom amount without performing complicated calculation. Further, by increasing the degree of zoom when the position change (body displacement) detected based on the acceleration is greater, the user can easily adjust the zoom amount and further can perform an operation intuitively.

Moreover, with the present embodiment, detection of a change of the acceleration in a predetermined time is determined to be jiggling of a hand, and zoom adjustment is not performed. Consequently, zoom processing that the user does not intend is prevented from being executed.

### Embodiment 2

A description is hereinafter provided regarding Embodiment 2 of the present invention. With Embodiment 2, a feature of deciding the degree of focus is added in addition to Embodiment 1.

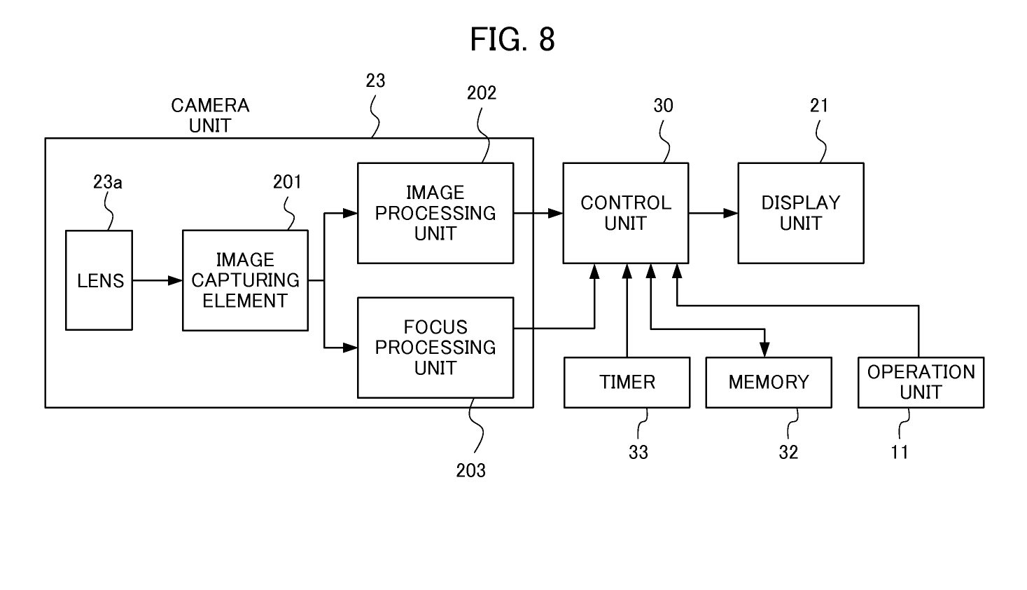

FIG. 8 is a block diagram showing features of the cellular telephone 1 according to the present embodiment. The camera unit 23 further has a focus processing unit 203 in addition to Embodiment 1 (FIG. 3).

The focus processing unit 203 clips a predetermined area of image data and integrates a differential component to detect a focus evaluation value indicating the degree of focus. With Embodiment 1, the control unit 30 performs zoom control based on the detected acceleration level. With Embodiment 2, the control unit 30 detects the position change (body displacement) of the cellular telephone 1 based on the focus evaluation value detected by the focus processing unit 203, and performs zoom control of the captured image based on this position change.

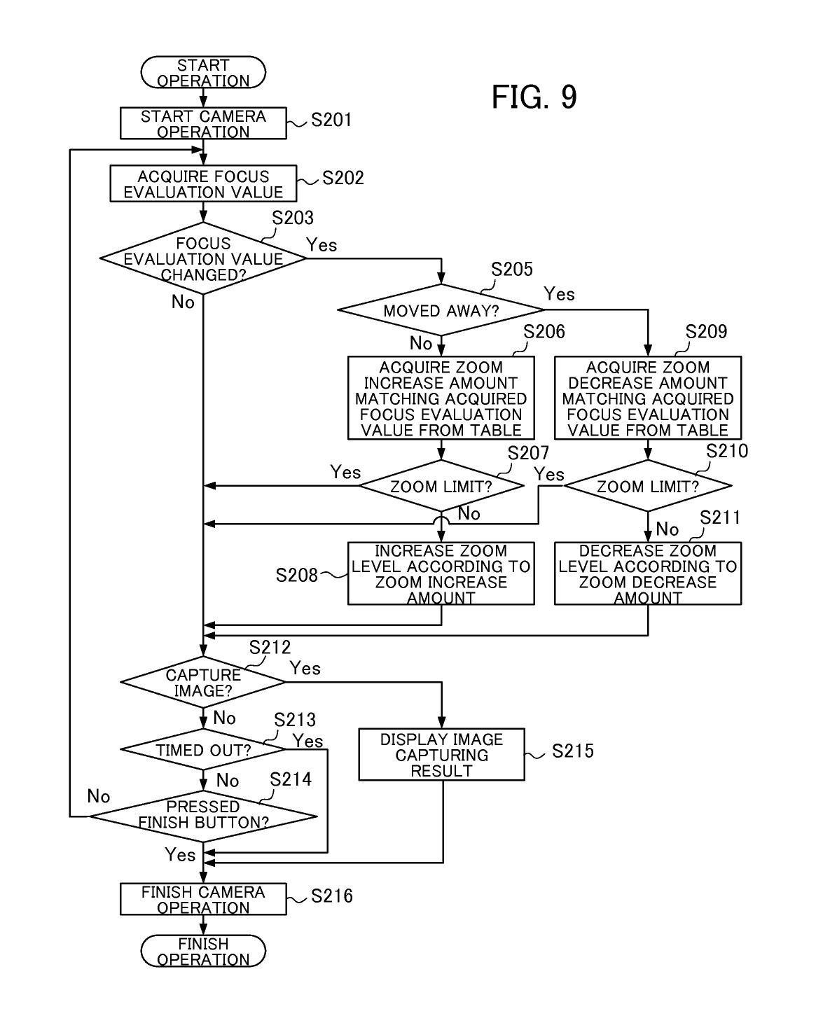

FIG. 9 is a flowchart showing processing of the control unit 30 according to the present embodiment. Steps S102 to S104 in Embodiment 1 (FIG. 7) are changed to steps S202 to S203, step S106 is changed to step S206 and step S109 is changed to step S209, and the other steps are the same as in Embodiment 1.

In step S202, the control unit 30 acquires a focus evaluation value indicating the degree of focus, from the focus processing unit 203. Here, the control unit 30 can refer to the transition of the focus evaluation value in a predetermined period up to this point of time by periodically acquiring focus evaluation values.

In step S203, the control unit 30 determines whether or not the focus evaluation value acquired in step S202 changed. The control unit 30 monitors the transition of focus evaluation values from the past, and determines that the focus evaluation value changed when a change corresponding to a predetermined threshold or greater takes place. Instead, when the focus evaluation value is greater and focus is adjusted, the focus evaluation value becomes small due to movement of the cellular telephone 1 and therefore the control unit 30 may determine that the focus evaluation value changed when it becomes smaller than a predetermined value. At this time, it is preferable that the control unit 30 adjusts the predetermined value according to a focal length. The control unit 30 moves the processing to step S205 when this determination is YES, and moves the processing to step S212 when this determination is NO.

Similar to the acceleration table (FIG. 4), in step S206 or step S209, the control unit 30 acquires the zoom increase amount or zoom decrease amount, from the table (not shown) associating the change of the focus evaluation value and the increase/decrease amount of the degree of zoom. Note that it is preferable to change the association between the change of the focus evaluation value and the zoom increase/decrease amount according to the focal length. In addition, the control unit 30 may detect the zoom increase/decrease amount based on a predetermined calculation rule according to the focal length.

With the present embodiment, as means for detecting the position change of the cellular telephone 1, the focus processing unit 203 is provided. This allows the cellular telephone 1 to detect the position change by utilizing the degree of focus of an image without adding components such as the acceleration sensor 31. Consequently, users can easily perform zoom up or zoom down by an intuitive operation.

In addition, with the present embodiment, the control unit 30 performs zoom processing when a focus evaluation value changes to be over a predetermined value. Consequently, the control unit 30 can prevent an unintentional zoom operation from being executed by a small change of the degree of focus due to, for example, jiggling of a hand.

Note that, with the present embodiment, the control unit 30 performs zoom processing when the amount of a change of a focus evaluation value is a predetermined value or more. In addition, the control unit 30 may perform zoom processing when the focus evaluation value decreases. When the focus evaluation value becomes greater, it is possible to determine that the user is moving the cellular telephone 1 to adjust the focus and, consequently, there is a possibility that the control unit 30 can prevent zoom processing that the user does not intend, by this processing.

### Embodiment 3

A description is hereinafter provided regarding Embodiment 3 of the present invention. With Embodiment 1, the control unit 30 stores the acceleration table (FIG. 4) in advance, and performs zoom control based on the stored zoom increase/decrease amount. By contrast with this, with Embodiment 3, the control unit 30 further has the feature of correcting data to be stored in this acceleration table.

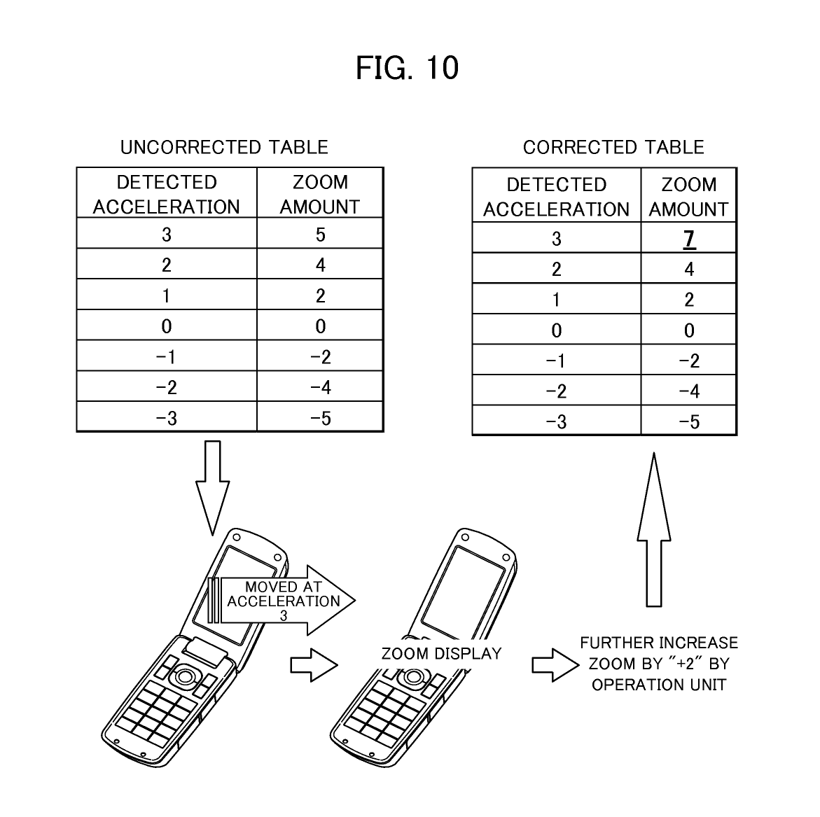

FIG. 10 is a diagram showing how the acceleration table according to the present embodiment is corrected. First, when the cellular telephone 1 is moved at the acceleration level “3,” the control unit 30 increases the zoom level by “5” based on the uncorrected table A.

Subsequently, when the zoom level is further changed by “+2” according to an operation inputted from the operation unit 11 within a predetermined time, the control unit 30 corrects the zoom increase amount matching the acceleration level “3” from “5” to “7,” and stores the corrected table B.

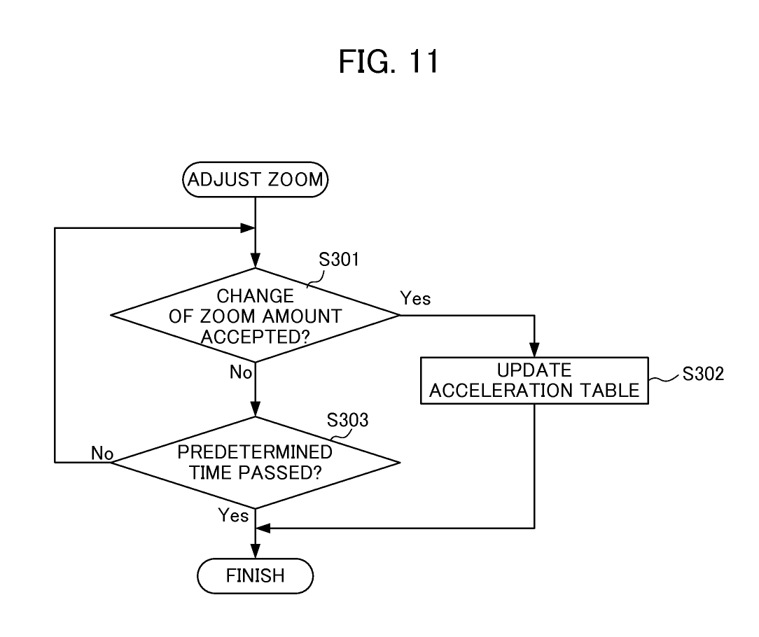

FIG. 11 is a flowchart showing processing of the control unit 30 according to the present embodiment. Here, “processing” means processing after the degree of zoom is adjusted according to the change of the acceleration.

In step S301, the control unit 30 determines whether or not an input to change the degree of zoom was accepted from the operation unit 11. The control unit 30 moves the processing to step S302 when this determination is YES, and moves the processing to step S303 when this determination is NO.

In step S302, the control unit 30 updates data of the acceleration table based on the input to change the degree of zoom accepted in step S301.

In step S303, the control unit 30 determines whether or not a predetermined time passed without accepting the input to change the degree of zoom in step S301. The control unit 30 finishes processing when this determination is YES, and returns processing to step S301 and continues accepting an input when this determination is NO.

According to the present embodiment, the amount of zoom control can change according to the operation inputted from the user. Consequently, the cellular telephone 1 according to the present embodiment can provide a zoom feature which is highly familiar with respective users.

In addition, the passing of a predetermined time in step S303 may be the time passed after the control unit 30 changes the degree of zoom based on the acceleration table. Further, the predetermined time may be, for example, several seconds.

According to such an embodiment, the control unit 30 updates data of the acceleration table by accepting from the operation unit 11 only correction from the user immediately after zoom is performed by the control unit 30. Consequently, the control unit 30 can update in the acceleration table only correction inputted to the operation unit 11 when the user wants to correct the degree of zoom. Consequently, the cellular telephone 1 according to the present embodiment can not only provide a zoom feature which is highly familiar with respective users, and further improve user-friendliness.

Although descriptions have been provided regarding embodiments of the present invention, the present invention is not limited to the above embodiments. In addition, the effects disclosed in the embodiments of the present invention have only been described as the most preferable effects resulting from the present invention, and the effects of the present invention are not limited to the effects disclosed in the embodiments of the present invention.

For example, means for detecting the position change may detect the position change of the cellular telephone 1 according to, for example, the transition of captured image data caused by movement of the cellular telephone 1 in the image capturing direction (for example, enlargement and reduction) or a distance measurement result using a ultrasonic wave, and only needs to be configured to detect the position change (body displacement) in the image capturing direction of the cellular telephone 1.

In addition, the zoom control according to the degree of focus and the zoom control according to the acceleration sensor may both be used. By so doing, the control unit 30 can perform more precise zoom control.

Furthermore, if the cellular telephone 1 has a macro mode for shortening the focal length for close-up, the control unit 30 may perform the above zoom processing when this macro mode is set. With the macro mode, the length to adjust focus is limited, and therefore the cellular telephone 1 cannot be moved substantially. Consequently, with the present embodiment, it is preferable that the above zoom processing realizes a desired zoom setting with a small amount of movement.

Moreover, if the cellular telephone 1 has the AF (Auto Focus) feature, the control unit 30 may perform the above zoom processing after the focus is successfully adjusted by the AF feature. There are cases where, after the focus is successfully adjusted, the position of the cellular telephone 1 is changed to adjust the zoom setting, and therefore there is a possibility that, by adding this condition, the control unit 30 can execute zoom processing at a timing that the user intends. Note that the above zoom processing may be executed until a predetermined time passes after the focus is successfully adjusted by the AF feature.

Note that it is preferable that the zoom processing according to the present invention is used to read the two-dimensional code such as QR code (registered trademark). That is, the size of an image and the degree of focus when the image of two dimensional code is captured influences the precision of reading substantially. Consequently, zoom control can easily be executed without substantially moving the cellular telephone 1, so that the user can read the two-dimensional code easily.

In addition, the zoom feature of the camera unit 23 according to the above embodiment is not limited to digital zoom by image processing, and may be optical zoom by displacing the lens unit 23a.

1. An electronic device comprising:
a body;
an image capturing unit disposed in the body;
a display unit that displays a captured image by the image capturing unit;
a zoom control unit that controls zoom of the captured image by the image capturing unit; and
a displacement detection unit that detects displacement of the body,
wherein the zoom control unit controls zoom of the captured image based on the displacement of the body detected by the displacement detection unit.

2. The electronic device according to claim 1, further comprising
an acceleration sensor that detects acceleration, and is provided in the body,
wherein the displacement detection unit detects the displacement of the body based on the acceleration detected by the acceleration sensor.

3. The electronic device according to claim 1, further comprising
a focus determination unit that determines a degree of focus of the captured image by the image capturing unit,
wherein the displacement detection unit detects the displacement of the body based on a change of the degree of focus of the captured image determined by the focus determination unit.

4. The electronic device according to claim 1, wherein the displacement detection unit detects the displacement of the body in an image capturing direction of the image capturing unit.

5. The electronic device according to claim 3, wherein the zoom control unit controls zoom of the captured image when the degree of focus determined by the focus determination unit changes to be over a predetermined value.

6. The electronic device according to claim 4, wherein the zoom control unit enlarges the captured image when the displacement detection unit detects the displacement of the body in a direction towards an object.

7. The electronic device according to claim 4, wherein the zoom control unit reduces the captured image when the displacement detection unit detects the displacement of the body in a direction away from an object.

8. The electronic device according to claim 1, wherein the zoom control unit controls the zoom of the image based on a degree of the displacement of the body detected by the displacement detection unit.

9. The electronic device according to claim 8, further comprising
a storage unit that stores data indicating a relationship between the degree of the displacement of the body and a degree of zoom,
wherein the zoom control unit extracts the degree of zoom associated with the degree of the displacement of the body detected by the displacement detection unit, from the data stored in the storage unit, and controls the zoom of the captured image according to the extracted degree of zoom.

10. The electronic device according to claim 1, further comprising
a zoom change command unit that commands a change of a degree of the zoom of the image,
wherein the zoom control unit controls the zoom of the image according to the detected displacement of the body and a zoom change command by the zoom change command unit.

11. The electronic device according to claim 10, wherein, when a zoom change is commanded by the zoom change command unit within a predetermined time after the displacement of the body is detected, the zoom control unit changes the zoom of the image according to the command.

12. The electronic device according to claim 1, wherein:
the displacement detection unit measures a continuation time of the displacement of the body; and
when the continuation time measured by the displacement detection unit is longer than a predetermined time, the zoom control unit controls the zoom of the captured image.

13. The electronic device according to claim 2, wherein the displacement detection unit detects the displacement of the body according to a maximum value of the acceleration detected by the acceleration sensor.

14. The electronic device according to claim 1, wherein the zoom control unit controls the zoom of the image based on the displacement of the body when a close-up mode is set.

15. An image capturing method in an electronic device comprising a display unit that displays a captured image by an image capturing unit provided in a body, the method comprising
detecting displacement of the body and controlling zoom of the captured image based on the detected displacement of the body.
